(19) United States
(12) Patent Application Publication
(10) Pub. No.: US 2012/0162699 A1
(43) Pub. Date: Jun. 28, 2012

(54) METHOD FOR PRINTING COMPRESSED IMAGES

(75) Inventor: Robert R. Buckley, Rochester, NY (US)

(73) Assignee: Xerox Corporation, Norwalk, CT (US)

(21) Appl. No.: 12/978,680

(22) Filed: Dec. 27, 2010

(51) Int. Cl. G06F 3/12

(52) U.S. Cl. 358/1.15

(57) ABSTRACT

A method for printing an image of a compressed hierarchical image format file determines a number of layers to be extracted from a codestream of the compressed hierarchical image format file needed to realize a predetermined printing requirement with respect to printing the image of the compressed hierarchical image format file. Information, identifying the number of layers needed to be extracted from the codestream to realize the predetermined printing requirement, is embedded. The number of layers identified by the embedded information is extracted from the codestream and the image is printed based upon the number of layers extracted from the codestream.

### BACKGROUND

In the modern workplace, printers can be used to print single copies of a document or millions of copies of a document. Before printing any copies of a document, a printer often receives a print job via a communications network. In many instances, the print job includes a description that is expressed in a page description language. The description typically contains the text and images that should be printed as well as the page layout for positioning the text and images. In other instances, the print job can be an image or series of images in an imaging format such as TIFF or JPEG. These images can contain both text and graphics.

A printer can be a single device, such as one of the commonly available desk top printers, or can be a multiple device system, such as a commercial printing solution. Commercial printing solutions can contain digital front ends, preprocessors, and marking engines. A marking engine is the device that actually prints the image (data) onto a substrate such as paper. A digital front end can accept print jobs, prioritize them, and process them into the format required by the marking engine. A preprocessor can also accept jobs and process them, but performs processing that the digital front end cannot or should not.

A digital image can be contained in a description. A digital image, such as those images that can be displayed on a computer monitor or are taken with a digital camera, is made of pixels. A pixel is a single spot of color, wherein white, black, and grey are considered colors. Most images are rectangular or square. For example, an 800×600 image is an image that is 800 pixels wide and 600 pixels high. The width and height of a digital image is the image's resolution.

Printers also have a resolution, but it is measured in dots per inch (dpi), spots per inch (spi), or a similar measure. For example, a 100 dpi (spi) image can print 100 dots (spots) of ink or toner in one inch. A printer that prints 100 dpi (spi) in both the height direction and the width direction can print an 800×600 pixel image as an 8 inch by 6 inch rectangle.

A description containing an image has defined space where that image is to be printed. For example, the description for a document can specify that an image is to be printed in a 2 inch by 2 inch square in the upper left corner of the document. A printer with 100 dpi (spi) resolution can print a 200×200 pixel image in a 2 inch by 2 inch square. A printer with 200 dpi (spi) resolution can print a 400×400 pixel image in the same square. A printer with 400 dpi (spi) resolution can print a 800×800 pixel image in the 2 inch by 2 inch square.

If the description contains image data for a 400×400 pixel image to be printed in the 2 inch by 2 inch square, only the 200 dpi (spi) printer can print the image at its natural resolution. The 100 dpi (spi) printer must print a lower resolution version. The 400 dpi (spi) printer must print a higher resolution version.

Those skilled in the art of image processing and printing know how to adapt the resolution of an image to match the resolution of a printer and the space in which to print the image.

Users often produce descriptions that can be used by a variety of different printers. The advantage is that the same description can be used without change by all the printers. Therefore, slightly different descriptions of the same document, but for different printers, need not be created. A problem that is thereby avoided is that a description intended for one printer is not accidentally submitted to a different printer.

Producing a single description for every printer also introduces problems. One problem with a one size fits all solution in the digital realm is that the size that fits all is usually the biggest size. Some printers can print in full color, and other printers can only print low resolution black dots on a white background. A description containing image data for a full color copy is wasted on the black/white printer. Transmitting the description can be costly, and the printer can be slow to process the image before printing.

An image can be transmitted in the form of image data. Image data must be in a known format in order for it to be used to form an image. Examples of conventional (known) formats include GIF, PNG, TIFF, JPEG, and JPEG 2000.

Of these conventional formats, JPEG 2000 is a compressed hierarchical image format, which is essentially a series of increasingly higher resolution versions of an image having multiple quality layers.

To print a JPEG 2000 image, one conventional method embeds the JPEG 2000 image in a portable document format (PDF) file. Another conventional method is to convert the JPEG 2000 image to another image format, such as TIFF or JPEG, which can then be printed using existing methods.

However, both of these conventional methods take the JPEG 2000 image as is, which means more data is accessed and sent to the printer or printed then is necessary because the JPEG 2000 image contains multiple resolutions and quality layers which the printer may not support or the user does not desire.

One advantage of using JPEG 2000 as an image format is that JPEG 2000 supports multiple decompression options. This includes decompression to reduced resolution or quality, which is enabled by the use of multiple resolution levels or quality layers respectively. The overall compression ratio, corresponding to the maximum quality and use of all layers, is set for the most demanding application, such as examining image detail on a screen at full resolution. However, this compression ratio and corresponding maximum quality is typically more than is required to generate a print of the image.

Therefore, it would be desirable to provide a method that identifies the number of layers needed to meet the printing requirement of the print job.

Moreover, it would be desirable to provide a method that determines a number of layers to be extracted from a codestream of a compressed hierarchical image format file needed to realize a predetermined printing requirement with respect to printing the image of the compressed hierarchical image format file and embeds information identifying the number of layers needed to be extracted from the codestream to realize the predetermined printing requirement.

In addition, determines a number of layers to be extracted from a codestream of a compressed hierarchical image format file needed to realize a predetermined printing requirement with respect to printing the image of the compressed hierarchical image format file; embeds information identifying the number of layers needed to be extracted from the codestream to realize the predetermined printing requirement; extracts, from the codestream, the number of layers identified by the embedded information; and prints the image of the compressed hierarchical image format file based upon the number of layers extracted from the codestream.

### BRIEF DESCRIPTION OF THE DRAWING

The drawings are only for purposes of illustrating various embodiments and are not to be construed as limiting, wherein:

FIG. 1 illustrates a method for embedding information identifying a number of layers to be extracted from a codestream of a compressed hierarchical image format file to realize a printing of an image of the compressed hierarchical image format file;

FIG. 2 illustrates a method for printing an image of a compressed hierarchical image format file; and

FIG. 4 illustrates a system for carrying out the methods illustrated in FIGS. 1 and 2.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

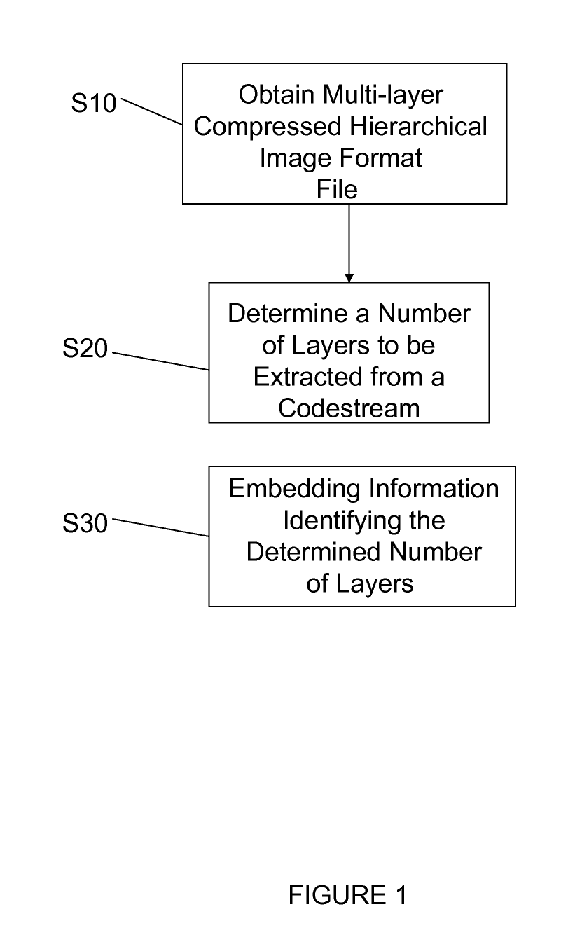

FIG. 1 illustrates, in a flowchart format, a method to embed information identifying a number of layers to be extracted from a codestream of a compressed hierarchical image format file to realize a printing of an image of the compressed hierarchical image format file.

As illustrated in FIG. 1, at step S10, a multi-layer compressed hierarchical image format file is obtained. The file may be a JPEG2000 file, JPEG/XR file, etc. At step S20, a number of layers to be extracted from the codestream needed to realize a predetermined printing requirement with respect to printing the image of the compressed hierarchical image format file is determined. Information, identifying the number of layers to be extracted from the codestream needed to realize a predetermined printing requirement with respect to printing the image of the compressed hierarchical image format file, is embedded, at step S30.

This information may be embedded in a comment of the codestream. This information may also be embedded in a universally unique identifier in the compressed hierarchical image format file or an extensible markup language box in the compressed hierarchical image format file.

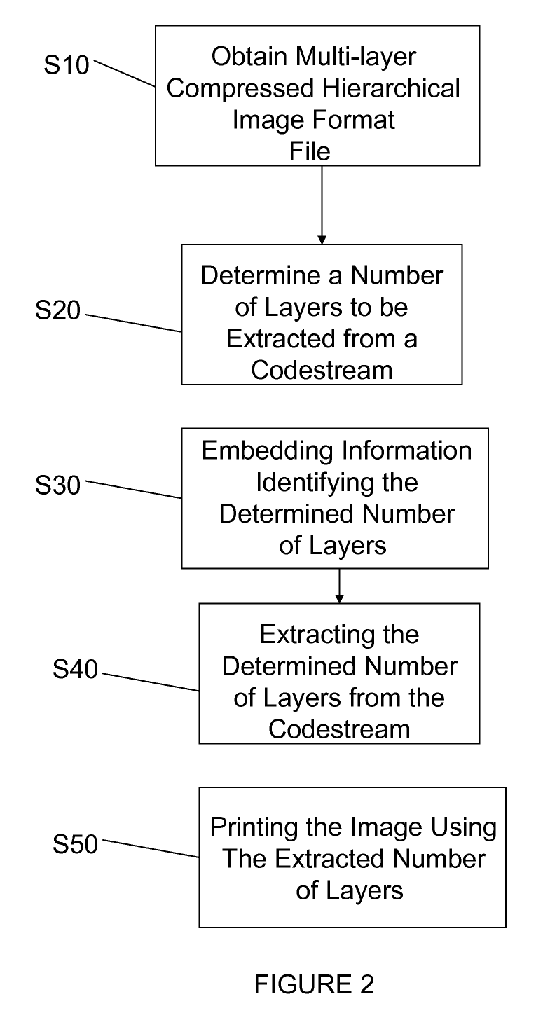

FIG. 2 illustrates, in a flowchart format, a method for printing an image of a compressed hierarchical image format file.

As illustrated in FIG. 2, at step S10, a multi-layer compressed hierarchical image format file is obtained. The file may be a JPEG2000 file, JPEG/XR file, etc.

At step S20, a number of layers to be extracted from the codestream needed to realize a predetermined printing requirement with respect to printing the image of the compressed hierarchical image format file is determined. Information, identifying the number of layers to be extracted from the codestream needed to realize a predetermined printing requirement with respect to printing the image of the compressed hierarchical image format file, is embedded, at step S30

This information may be embedded in a comment of the codestream. This information may also be embedded in a universally unique identifier in the compressed hierarchical image format file or an extensible markup language box in the compressed hierarchical image format file.

At step S40, the determined number of layers is extracted from the codestream, and at step S50, the image is printed, by the printer (printer 20 of FIG. 3) using the extracted number of layers.

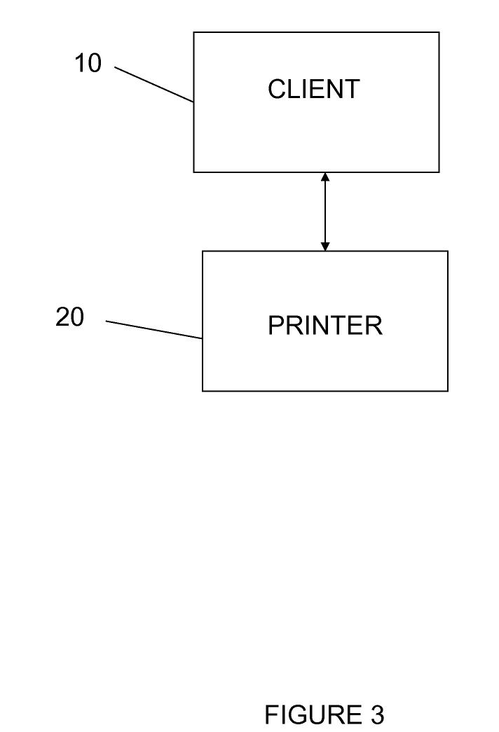

FIG. 4 illustrates a system which executes the methods illustrated in FIGS. 1 and 2.

As illustrated in FIG. 3, a client 10 is operatively connected to a printer 20 to enable the printing of the image of the compressed hierarchical image format file.

The client 10 may determine number of layers to be extracted from the codestream needed to realize a predetermined printing requirement with respect to printing the image of the compressed hierarchical image format file is determined. The client 10 may embed information, identifying the number of layers to be extracted from the codestream needed to realize a predetermined printing requirement with respect to printing the image of the compressed hierarchical image format file. Lastly, the client 10 may also extract the determined number of layers and provide them to the printer 20.

As is known to those skilled in the art, a JPEG2000 codestream support layers, which allow a single codestream to supply images at multiple compression ratios. One or more of the compression ratios, corresponding one or more codestream subsets, can be used for printing.

Since printing is a lossy process, the subset used for printing would correspond to a higher compression ratio. In other words, less data would be transmitted and decompressed, which leads to smaller files and faster decompression times.

By identifying and associating layers in a JPEG2000 codestream for particular printing requirements, enables the use of fewer layers in the printing process.

When a JPEG 2000 compressed image is decompressed at a reduced resolution, the image can also be decompressed with fewer layers, since decompression artifacts are less visible in reduced-size images. A method that allows for decompressing less layers is described in U.S. patent application Ser. No. 11/311,876 and U.S. patent application Ser. No. 11/359,715. The entire contents of U.S. patent application Ser. No. 11/311,876 and U.S. patent application Ser. No. 11/359,715 are hereby incorporated by reference.

In addition, a JPEG 2000 compressed image may be sized appropriately for printing by using only as many resolution levels as are needed to match the resolution of the printer. A method that allows for using only as many resolution levels as are needed to match the resolution of the printer is described in U.S. patent application Ser. No. 11/195,194. The entire content of U.S. patent application Ser. No. 11/195,194 is hereby incorporated by reference.

The above-described processes links the use of quality layers in a JPEG 2000 compressed image to printing requirements and the printing process. It is noted that these processes can also be applied to other formats that offer some level of quality scalability, such as JPEG/XR, formerly known as Microsoft™ HD Photo.

Moreover, the above-described processes reduce the quality of a JPEG 2000 image significantly before the artifacts became visible on the printed page. To realize the reduction in quality, a multi-layer JPEG 2000 codestream, with one or more layers that may not be visually lossless for screen viewing but that would be visually lossless for printing, is obtained or used.

The above-described processes use a mechanism for selecting and then extracting the layers to be used for printing. It is noted that creating multi-layer codestreams and extracting layers upon decompression are well-known processes enabled by the JPEG 2000 standard, thus the selection mechanism and its use in a printing pipeline is the focus of the above-described processes.

The selection mechanism includes a way of identifying the layers to be used for printing so that the layers can be accessed when printable data is extracted from the codestream.

Although most applications do not “label” layers in the codestream, Kakadu™ is an application that does “label” layers in the codestream such that comment fields in the codestream gives the slope value and the size of each layer.

Thus, it is possible to add up the layer sizes until a desired compression ratio is reached. Moreover, it is possible to select the layers up to the desired slope threshold, since slope is better correlated with quality than compression ratio.

The above-described processes provide an alternative to using the above described “labeled” layers, by embedding, in the codestream, a comment that explicitly indicates the layers to be used for printing.

It is noted that not all printers are the same, thus, some printers may use fewer layers than other printers.

To realize one embodiment of the above-described processes, a first application creates a comment such as:
print mode—layers 5.

The first application embeds this comment in the codestream where a printing application makes use of the embedded comment, by transcoding or decompressing only five layers of the codestream, in accordance with the embedded comment, “print mode—layers 5.”

This comment may also be embedded in a file containing the codestream. For example, the comment may be embedded in a universally unique identifier or extensible markup language box in the compressed hierarchical image format file (JPEG 2000). In this embodiment, the printing application would makes use of the embedded comment, by transcoding or decompressing only five layers of the codestream, in accordance with the embedded comment, “print mode—layers 5.”

It is noted that the embedding of information is not limited to a single comment. For example, the information may delineate between the quality of the print mode. In this example, separate comments may be used for draft and fine print modes, such as:
fine print mode—layers 5
draft print mode—layers 3

The printing application makes use of the embedded comment, by transcoding or decompressing five layers of the codestream when printing in a fine print mode, in accordance with the embedded comment, “fine print mode—layers 5” and transcodes or decompresses three layers of the codestream when printing in a draft print mode, in accordance with the embedded comment, “draft print mode—layers 3.”

In another example, the information may delineate between the resolution of the printing process, such as:
200 dpi print mode—layers 5
300 dpi print mode—layers 6

In this case, the number of layers would be coupled to the number of resolution (or decomposition) levels that are decompressed or transcoded. This would be useful in the case of large images at higher than normal print resolutions or larger than normal print sizes.

The printing application makes use of the embedded comment, by transcoding or decompressing five layers of the codestream when printing in a 200 dpi print mode, in accordance with the embedded comment, “200 dpi print mode—layers 5” and transcodes or decompresses six layers of the codestream when printing in a 300 dpi print mode, in accordance with the embedded comment, “300 dpi print mode—layers 6.”

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of embedding information identifying a number of layers to be extracted from a codestream of a compressed hierarchical image format file to realize a printing of an image of the compressed hierarchical image format file, comprising:
determining, using a processor, a number of layers to be extracted from the codestream needed to realize a predetermined printing requirement with respect to printing the image of the compressed hierarchical image format file; and
embedding, using the processor, information identifying the number of layers needed to be extracted from the codestream to realize the predetermined printing requirement.

2. The method as claimed in claim 1, wherein the predetermined printing requirement is a predetermined quality print mode.

3. The method as claimed in claim 2, wherein the predetermined quality print mode is a draft print mode.

4. The method as claimed in claim 3, wherein the embedded information indicates that the draft print mode needs a lesser number of layers to be extracted from the codestream than a fine print mode.

5. The method as claimed in claim 2, wherein the predetermined quality print mode is a fine print mode.

6. The method as claimed in claim 5, wherein the embedded information indicates that the fine print mode needs a greater number of layers to be extracted from the codestream than a draft print mode.

7. The method as claimed in claim 1, wherein the predetermined printing requirement is a predetermined resolution print mode.

8. The method as claimed in claim 7, wherein the predetermined resolution print mode is a predetermined dots per inch print mode.

9. The method as claimed in claim 7, wherein the embedded information indicates a number of layers to be extracted from the codestream for a first predetermined resolution print mode and a number of layers to be extracted from the codestream for a second predetermined resolution print mode, the number of layers to be extracted from the codestream for the first predetermined resolution print mode being less than the number of layers to be extracted from the codestream for the second predetermined resolution print mode.

10. The method as claimed in claim 1, wherein the information is an embedded comment in the codestream.

11. The method as claimed in claim 1, wherein the information is embedded in a universally unique identifier in the compressed hierarchical image format file.

12. The method as claimed in claim 1, wherein the information is embedded in an extensible markup language box in the compressed hierarchical image format file.

13. A method for printing an image of a compressed hierarchical image format file, comprising:
determining, using a processor, a number of layers to be extracted from a codestream of the compressed hierarchical image format file needed to realize a predetermined printing requirement with respect to printing the image of the compressed hierarchical image format file;
embedding, using the processor, information identifying the number of layers needed to be extracted from the codestream to realize the predetermined printing requirement;
extracting, from the codestream, the number of layers identified by the embedded information; and
printing the image of the compressed hierarchical image format file based upon the number of layers extracted from the codestream.

14. The method as claimed in claim 13, wherein the predetermined printing requirement is a predetermined quality print mode.

15. The method as claimed in claim 13, wherein the predetermined quality print mode is a draft print mode.

16. The method as claimed in claim 13, wherein the predetermined quality print mode is a fine print mode.

17. The method as claimed in claim 13, wherein the predetermined printing requirement is a predetermined resolution print mode.

18. The method as claimed in claim 13, wherein the information is an embedded comment in the codestream.

19. The method as claimed in claim 13, wherein the information is embedded in a universally unique identifier in the compressed hierarchical image format file.

20. The method as claimed in claim 13, wherein the information is embedded in an extensible markup language box in the compressed hierarchical image format file.
